(19) United States
(12) Patent Application Publication
(10) Pub. No.: US 2017/0144862 A1
(43) Pub. Date: May 25, 2017

(54) REMOVABLE CAR OPERATING PANEL

(71) Applicant: Otis Elevator Company, Farmington, CT (US)

(72) Inventors: Juan Jose Fernandez, Madrid (US); Antonio de Miguel Urquijo, Madrid (ES); Francisco Luis Sanz, Madrid (ES); Ricardo Cano-Torres, Madrid (ES); Francisco Morate, Madrid (ES)

(21) Appl. No.: 15/300,394

(22) PCT Filed: Apr. 2, 2014
(86) PCT No.: PCT/US2014/032716

§ 371 Date: Sep. 29, 2016

(51) Int. Cl. B66B 11/02; B66B 5/00; B66B 1/34; B66B 1/50

(52) U.S. Cl. CPC B66B 11/0246; B66B 1/50; B66B 5/0018; B66B 5/0043; B66B 1/3476; B66B 9/00

(57) ABSTRACT

A car panel for an elevator car, a method for assembling an elevator car, and an elevator system are disclosed. The car panel of the elevator car includes a lower portion, the lower portion attached to a floor of the elevator car and an upper portion, the upper portion attached to a side panel by a hinge. The hinge allows the upper portion to displace, with respect to the lower portion, by rotating the upper portion inwardly about the hinge towards an interior space of the elevator car. Displacement of the upper portion, with respect to the lower portion, from rotating the upper portion inwardly about the hinge provides ingress to a hoistway of the elevator system.

### TECHNICAL FIELD OF THE DISCLOSURE

The present disclosure relates to elevator systems and, more specifically, to a car panel for an elevator car within an elevator system.

### BACKGROUND OF THE DISCLOSURE

Elevator systems, generally, include one or more elevator cars disposed in a hoistway and associated motors, or other prime movers, operatively connected to the elevator car in order to generate a thrust force to move the elevator car within the hoistway. As such, an elevator system is comprised of a multitude of mechanical and/or electrical elements.

Some elements associated with the elevator system are located outside of the interior space of the elevator car. For example, elements of the elevator system, such as safety boxes, dead end hitches, load weighing devices, and the like, may be disposed in the hoistway and/or on the exterior of the elevator car. To properly maintain such an elevator system, access to this multitude of mechanical and/or electrical elements located outside of the car is required.

In prior elevator systems, access to elements on the exterior of the elevator car is accomplished by having a technician enter the hoistway. A user (e.g., an operator, a technician, etc.) could gain access by entering on a floor where the elevator car is not located and repelling and/or hoisting himself or herself about the hoistway. However, in some elevator systems the area between the hoistway and the side of an elevator car is too narrow for a technician to fit, limiting access to the elements.

Designers of modern elevator systems aim to create elevator systems having narrow hoistways because a narrow hoistway occupies less space in a building. To access exterior elements in narrow hoistways, some elevator systems have been designed with fully removable elevator car panels which allow the technician to gain access to the hoistway and/or associated elements of the elevator system. However, removing car panels may be cumbersome and time consuming. As such, a need exists for an elevator car design having a car panel which allows fast, easy access to the hoistway and associated elements.

### SUMMARY OF THE DISCLOSURE

In accordance with one aspect of the disclosure, a car panel for an elevator car in an elevator system is disclosed. The elevator system may include a hoistway. The car panel of the elevator car may include a lower portion, the lower portion attached to a floor of the elevator car and an upper portion, the upper portion attached to a side panel by a hinge. The hinge may allow the upper portion to displace, with respect to the lower portion, by rotating the upper portion inwardly about the hinge towards an interior space of the elevator car. Displacement of the upper portion, with respect to the lower portion, from rotating the upper portion inwardly about the hinge may provide ingress to the hoistway.

In a refinement, an electronic control component associated with the elevator system may be integrated within the upper portion.

In a further refinement, the electronic control component associated with the elevator system may be a control panel.

In another further refinement, the electronic control component associated with the elevator system may include a user control element provided on an inward facing surface of the car panel and electronics associated with the user control element.

In a further refinement, rotating the upper portion inwardly about the hinge provides ingress to the electronics associated with the user control element.

In a refinement, the displacement from rotating the upper portion inwardly about the hinge provides ingress to load weighing devices associated with the elevator system.

In a refinement, the elevator car may further include a safety switch, the safety switch stopping motion of the elevator car within the hoistway if the upper portion is displaced with respect to the lower portion.

In accordance with another aspect of the disclosure, a method for assembling an elevator car of an elevator system is disclosed. The elevator car may include a car panel, a side panel, and a floor. The method may include attaching a lower portion of the car panel to the floor and attaching an upper portion of the car panel to the side panel using a hinge. The hing may allow the upper portion to displace, with respect to the lower portion, by rotating the upper portion inwardly about the hinge towards an interior space of the elevator car. The method may include providing ingress to a hoistway of the elevator system from the elevator car when the upper portion is displaced with respect to the lower portion.

In a refinement, the method may further include integrating an electronic control component associated with the elevator system within the upper portion.

In a further refinement, the electronic control component may be a control panel.

In another further refinement, the electronic control component associated with the elevator system may include a user control element provided on an inward facing surface of the car panel and electronics associated with the user control element.

In a further refinement, the method may include providing ingress to the electronics associated with the user control element when the upper portion is displaced with respect to the lower portion.

In a refinement, the method may further include providing ingress to load weighting devices associated with the elevator system when the upper portion is displaced with respect to the lower portion.

In a refinement, the method may include providing a safety switch, the safety switch stopping motion of the elevator car within the hoistway if the upper portion is displaced with respect to the lower portion.

In accordance with another aspect of the disclosure, an elevator system is disclosed. The elevator system may include a hoistway and an elevator car disposed in the hoistway, the elevator car including a car panel. The car panel may include a lower portion, the lower portion attached to a floor of the elevator car and an upper portion attached to a side panel by a hinge. The hinge may allow the upper portion to displace, with respect to the lower portion, by rotating the upper portion inwardly about the hinge towards an interior space of the elevator car. Displacement of the upper portion, with respect to the lower portion, from rotating the upper portion inwardly about the hinge may provide ingress to the hoistway.

### BRIEF DESCRIPTION OF THE DRAWINGS

FIG. 1 is a representation of an elevator system, according to an exemplary embodiment.

FIG. 2 is a front view of an exemplary elevator panel of an elevator car in an exemplary embodiment.

FIG. 3 is a rear perspective view of the elevator panel of the elevator car of FIG. 2, wherein the perspective is from a hoistway of an associated elevator system.

FIG. 4 is a perspective view of the elevator panel of the elevator car of FIG. 2, wherein the perspective is from the interior of the elevator car and an upper portion of the elevator panel is opened inwardly towards the interior of the elevator car, revealing the hoistway of FIG. 3.

FIG. 5 is a rear perspective view of the elevator panel of FIG. 2, wherein the perspective is from the hoistway of the associated elevator system and the upper portion of the elevator car is opened inwardly towards the interior of the elevator car as in FIG. 4.

FIG. 6 is a front view of an exemplary elevator panel of an elevator car in an exemplary embodiment, the elevator car having an integrated operating panel.

FIG. 7 is a flow chart for an exemplary process for assembling an elevator panel in accordance with the present disclosure.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE DRAWINGS

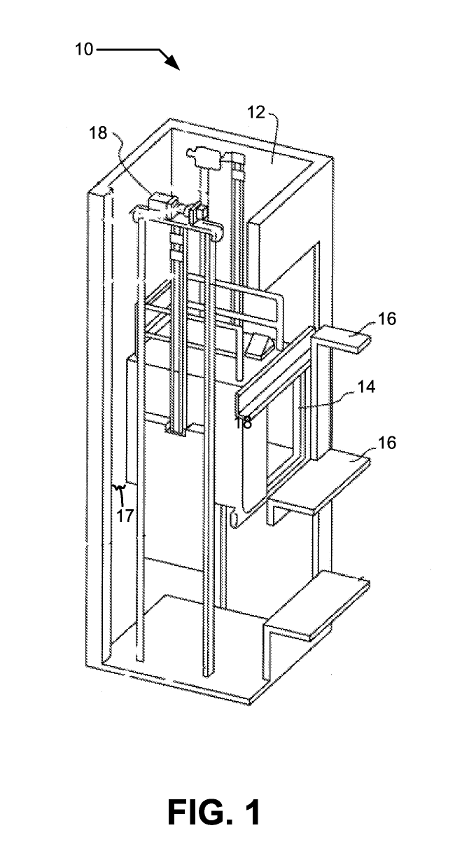

Referring now to FIG. 1, a schematic diagram of an elevator system 10 is provided. It is to be understood that the depicted elevator system of FIG. 1 is for illustrative purposes only and to assist in disclosing various embodiments of the invention. As is understood by a person skilled in the art, FIG. 1 does not depict all of the components of an exemplary elevator system, nor are the depicted features necessarily included in all elevator systems.

The elevator system may include a hoistway 12 that is vertically disposed within a building. The hoistway 12 may provide a vertical path through which an elevator car 14 may travel between floors or landings 16 of the building. A motor 18, or other prime mover, may be operatively connected to the elevator car 14 in order to generate a thrust force to move the elevator car 14 within the hoistway 12.

To limit the amount of space that the example elevator system 10 consumes in a building, the elevator system may be designed to minimize the size of the gap 17 between the walls of the elevator car 14 and the hoistway 12. In narrowing the gap 17, the elevator system 10 may allow for a narrower hoistway 12, thus allowing the elevator system 10 to fit into more compact areas within a building.

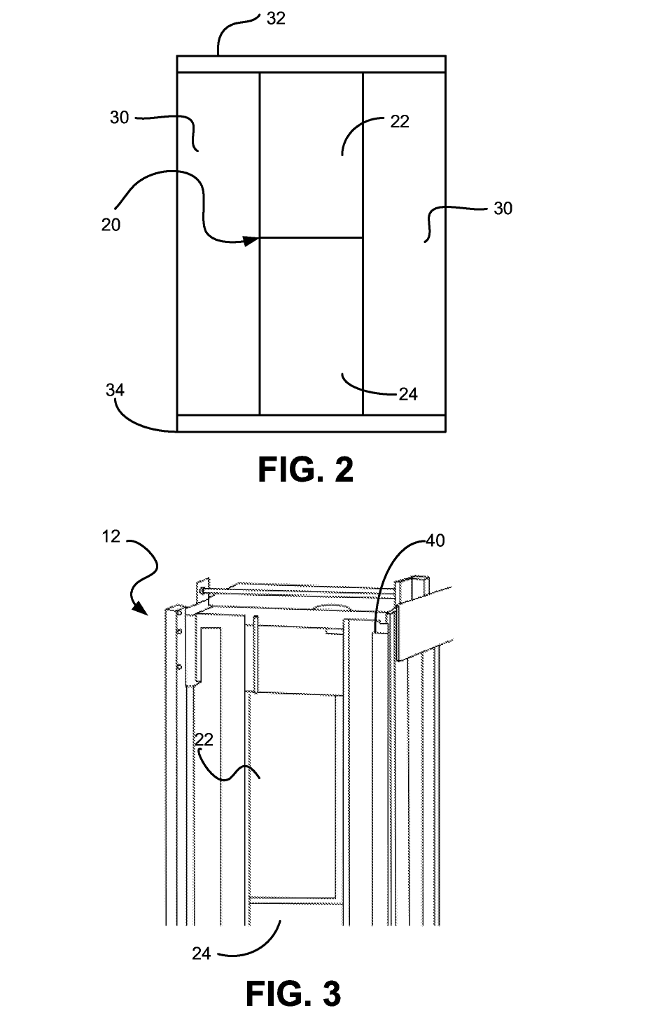

Generally, the elevator car 14 is an enclosed compartment traveling about the hoistway 12 and having, at least, a floor, a ceiling, a door, and a plurality of walls. Elements of an exemplary elevator car 14 and its interior and exterior are shown in FIGS. 2-5.

Beginning with a front view from within the exemplary elevator car 14 in FIG. 2, the elevator car 14 is shown having a floor 34, a ceiling 32, and a wall having a car panel 20 and side panels 30. The car panel 20 may be divided into an upper portion 22 and a lower portion 24. The lower portion of the car panel 20 is attached to the floor 34 and may be further attached to one or more side panels 30. The side panels 30 may be further attached to other panels and/or doors at their sides opposite of the side connected to the upper portion 22 and lower portion 24.

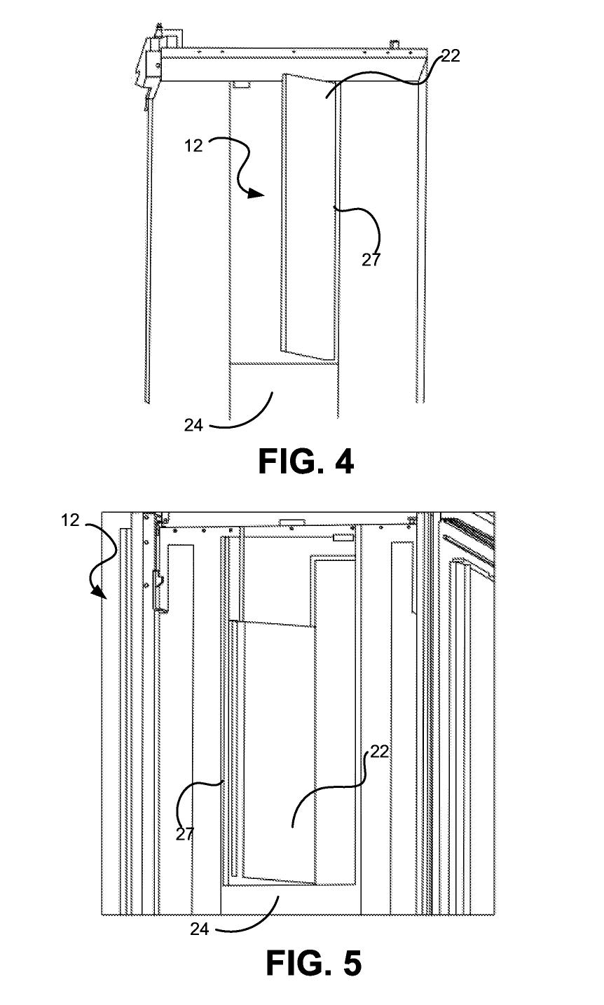

The upper portion 22 of the car panel 20 is aligned, at its top boundary, with the ceiling 32 and further aligned, at its bottom boundary, with the lower portion 24. The upper portion may be attached to a side panel 30 by a hinge 27. The hinge 27 allows the upper portion 22 to be displaced, with respect to the static lower portion 24, by rotating the upper portion 24 inwardly, about the hinge 27, towards the interior space of the elevator car 24. The displacement of the upper portion 22, with respect to the lower portion 24, may be analogous to “opening” a door. Further, the displacement of opening the upper portion 22 by rotating it inwardly about the hinge 27 provides ingress to the hoistway 12 for a user (a technician, an operator, etc.) within the elevator car 14. The upper portion 22 is shown opened from inside the elevator car 14 in FIG. 4 and the opened upper portion 22 is seen from the perspective of the hoistway in FIG. 5.

By providing ingress to the hoistway 12, the car panel 20 allows a technician responsible for the elevator system 10 access to equipment associated with the hoistway 12 and/or the exterior of the elevator car 14 from inside the elevator car 14. For example, the elevator system 10 may include safety boxes, dead end hitches, load weighing devices, and/or any other components associated with an elevator system (not shown) disposed in the hoistway 12 and/or the exterior of the elevator car 14. The upper portion 22, when opened, provides easy, fast, and safe access to said components.

Further, additional features may be included with the car panel 20 to improve safety of the environment within the elevator car 14. As seen in FIG. 3, a safety switch 40 associated with the upper portion 22 may be included. The safety switch 40 may be disposed in a location on the elevator car 24 wherein the safety switch 40 will have contact with the upper portion when the upper portion 22 is displaced with respect to the lower portion 24. When the safety switch 40 is in contact with the upper portion 22, it may send a signal to control components of the elevator system 10. The signal sent to the control components may also trigger a warning alert (e.g., an audible warning, a visual warning cue, etc.).

Further, when the upper portion 22 is in contact with the safety switch 40, an emergency stop operation may be performed. In an example safety stop operation, example control components may receive the signal from the safety switch 40 and subsequently halt movement of the elevator car 14. Additionally or alternatively, the safety stop operation may trigger a warning alert to the inhabitants of the car, informing the inhabitants to “close” the upper portion 22. Once the upper portion 22 is aligned with the lower portion 24 and ingress to the hoistway is unavailable, the elevator car 44 may resume motion about the hoistway 12

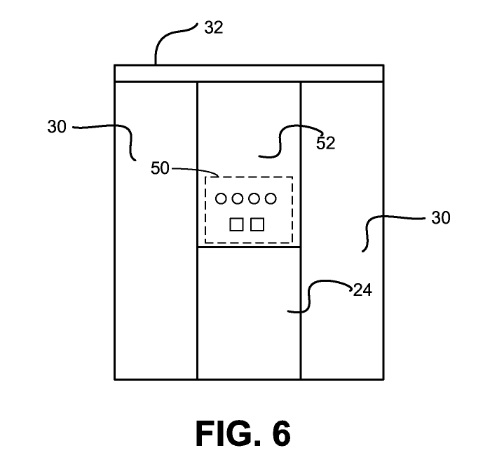

Turning now to FIG. 6, an additional embodiment of an upper portion 52 of the car panel 20 is shown. The upper portion 52 may include an electronic control component 50 associated with the elevator system 10 integrated within the upper portion 22. The electronic control component 50 may include a control panel for the elevator system 10. A control panel may, for example, allow passengers to select a desired floor 16 as a destination.

In some examples, the electronic component 50 includes a user control element provided on the inward facing surface of the car panel and additional, unseen electronics associated with the user control element. The unseen electronics may be located on the back (hoistway facing) face of the upper portion 22 or any other exterior location associated with the elevator car 14. Additionally or alternatively, the additional electronics may be disposed within the upper portion 22. When the upper portion 22 is opened, ingress may be provided to the additional electronics and/or any part of the electronic component 50.

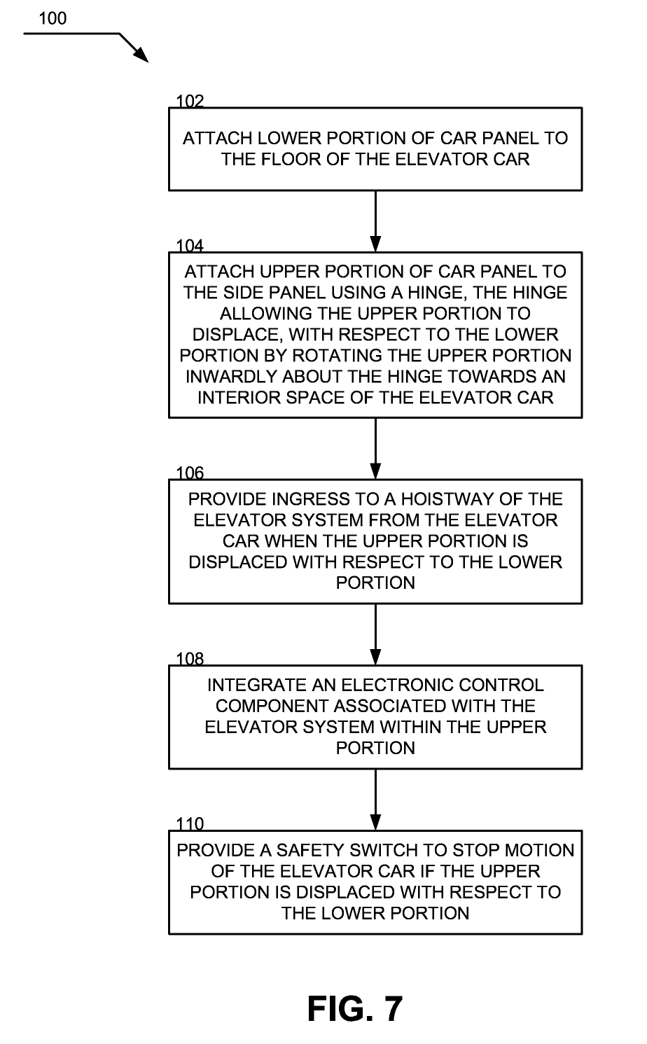

In accordance with the example flowchart 100 of FIG. 7, an example process 100 for assembling the car panel 20 of the elevator car 14 is shown. The process begins when a lower portion 24 of the car panel 20 is attached to the floor 34 of the elevator car 14 (block 102). An upper portion 22 of the car panel 20 may be attached to a side panel 30 using a hinge 27, the hinge 27 allowing the upper portion 22 to displace, with respect to the lower portion 24, by rotating the upper portion 22 inwardly about the hinge 27 towards an interior space of the elevator car 14 (block 104). Such an arrangement provides ingress to a hoistway 12 of an elevator system 10, in which the elevator car 14 is disposed, when the upper portion 22 is displaced with respect to the lower portion 24 (block 106).

At block 108, an electronic control component 50 associated with the elevator system 10 may be integrated within the upper portion 22 (block 108). The electronic control component may be a control panel associated with the elevator system.

Further, the process 100 may include providing a safety switch 40 to stop motion of the elevator car 14 if the upper portion 22 is displaced with respect to the lower portion 24 (block 110). The safety switch may generate a signal which causes the elevator to stop. Additionally, the signal may trigger a warning alert (e.g., an audible warning, a visual warning cue, etc.) to inhabitants of the elevator car.

### INDUSTRIAL APPLICABILITY

From the foregoing, it can be seen that the technology disclosed herein has industrial applicability in a variety of settings such as, but not limited to, design and implementation of panels within elevator cars. Using the teachings of the present disclosure, a technician or other operator of an elevator system may be provided with fast, easy, and safe access to components of the elevator system located on the exterior of the elevator car. The present invention is especially useful in applications wherein the hoistway is very narrow with respect to the elevator car. Said improvements may decrease the time needed for proper maintenance and repairs, and thusly, lower costs associated with operating an elevator system.

While the present disclosure has been in reference to design and implementation of panels within elevator cars, one skilled in the art will understand that the teachings herein can be used in other applications as well. It is therefore intended that the scope of the invention not be limited by the embodiments presented herein as the best mode for carrying out the invention, but that the invention will include all equivalents falling within the spirit and scope of the claims as well.

What is claimed is:

1. A car panel (20) for an elevator car (14) in an elevator system (10), the elevator system (10) including a hoistway (12), the car panel (20) comprising:
a lower portion (24), the lower portion (24) attached to a floor (34) of the elevator car (14); and
an upper portion (22), the upper portion (22) attached to a side panel (30) by a hinge (27), the hinge (27) allowing the upper portion (22) to displace, with respect to the lower portion (24), by rotating the upper portion (22) inwardly about the hinge (27) towards an interior space of the elevator car (14), displacement of the upper portion (22), with respect to the lower portion (24), from rotating the upper portion (22) inwardly about the hinge (27) providing ingress to the hoistway (12).

2. The car panel (20) of claim 1, wherein an electronic control component (50) associated with the elevator system is integrated within the upper portion (52).

3. The car panel (20) of claim 2, wherein the electronic control component (50) associated with the elevator system (10) is a control panel.

4. The car panel (20) of claim 2, wherein the electronic component (50) associated with the elevator system (10) includes a user control element provided on an inward facing surface of the car panel (20) and electronics associated with the user control element.

5. The car panel (20) of claim 4, wherein rotating the upper portion (52) inwardly about the hinge (27) provides ingress to the electronics associated with the user control element.

6. The car panel (20) of claim 1, wherein the displacement from rotating the upper portion (22) inwardly about the hinge (27) provides ingress to load weighing devices associated with the elevator system (10).

7. The car panel (20) of claim 1, further comprising a safety switch (40), the safety switch (40) stopping motion of the elevator car (14) within the hoistway (12) if the upper portion (22) is displaced with respect to the lower portion (24).

8. A method for assembling an elevator car panel (20) of an elevator car (14), in an elevator system (10), the elevator car (14) including the car panel (20), a side panel (30), and a floor (34), the method comprising:
attaching a lower portion (24) of the car panel (20) to the floor (34);
attaching an upper portion (22) of the car panel (20) to the side panel (30) using a hinge (27), the hinge (27) allowing the upper portion (22) to displace, with respect to the lower portion (24), by rotating the upper portion (22) inwardly about the hinge (27) towards an interior space of the elevator car (14); and
providing ingress to a hoistway (12) of the elevator system (10) from the elevator car (14) when the upper portion (22) is displaced with respect to the lower portion (24).

9. The method of claim 8, further comprising integrating an electronic control component (50) associated with the elevator system (10) within the upper portion (52).

10. The method of claim 9, wherein the electronic control component (50) is a control panel.

11. The method of claim 9, wherein the electronic component (50) associated with the elevator system (10) includes a user control element provided on an inward facing surface of the car panel (20) and electronics associated with the user control element.

12. The method of claim 11, further comprising providing ingress to the electronics associated with the user control element when the upper portion (22) is displaced with respect to the lower portion (24).

13. The method of claim 8, further comprising providing ingress to load weighting devices associated with the elevator system (10) when the upper portion (22) is displaced with respect to the lower portion (24).

14. The method of claim 8, further comprising providing a safety switch (40), the safety switch (40) stopping motion of the elevator car (12) within the hoistway (14) if the upper portion (22) is displaced with respect to the lower portion (24).

15. An elevator system (10), comprising:
a hoistway (12); and
an elevator car (14) disposed in the hoistway (12), the elevator car (14) including a car panel (20), the car panel (20) comprising:
a lower portion (24), the lower portion (24) attached to a floor (34) of the elevator car (14);
an upper portion (22), the upper portion (22) attached to a side panel (30) by a hinge (27), the hinge (27) allowing the upper portion (22) to displace, with respect to the lower portion (24), by rotating the upper portion (22) inwardly about the hinge (27) towards an interior space of the elevator car (14), displacement of the upper portion (22), with respect to the lower portion (24), from rotating the upper portion (22) inwardly about the hinge (27) providing ingress to the hoistway (12).

16. The elevator system (10) of claim 15, further comprising load weighing devices, wherein the displacement from rotating the upper portion (22) inwardly about the hinge (27) provides ingress to the load weighting devices.

17. The elevator system (10) of claim 15, further comprising a safety box, wherein the displacement from rotating the upper portion (22) inwardly about the hinge (27) provides ingress to the safety box.

18. The elevator system (10) of claim 15, further comprising dead end hitches, wherein the displacement from rotating the upper portion (22) inwardly about the hinge (27) provides ingress to the dead end hitches.

19. The elevator system (10) of claim 15, further comprising a safety switch (40), the safety switch (40) stopping motion of the elevator car (14) within the hoistway (12) if the upper portion (22) is displaced with respect to the lower portion (24).

20. The elevator system (10) of claim 15, further comprising a control panel (50), wherein the control panel (50) is integrated within the upper portion (52) of the car panel (20).
